(19) United States
(12) Patent Application Publication
(10) Pub. No.: US 2016/0076576 A1
(43) Pub. Date: Mar. 17, 2016

(54) DISPOSABLE ALIGNER FOR SELF-TAPPING THREADED INSERT

(71) Applicant: SHILO TECHNOLOGIES LTD., Maale Adumim (IL)

(72) Inventors: Ze'ev STAHL, Jerusalem (IL); Moshe AVRAHAM, Mobile Post Ephraim (IL)

(21) Appl. No.: 14/783,960

(22) PCT Filed: Dec. 4, 2013
(86) PCT No.: PCT/IL2013/050995

§ 371 Date: Oct. 12, 2015

(30) Foreign Application Priority Data
Dec. 9, 2012 (IL) 223516

(51) Int. Cl. F16B 37/12; F16B 33/00

(52) U.S. Cl. CPC F16B 37/127; F16B 33/00

(57) ABSTRACT

An aligner for use with threaded self tapping insert, a drive bolt, and a bushing, wherein said self tapping insert is driven into position in an accepting bore by said drive bolt passed through said bushing and through said self-tapping insert thread and fitted with said aligner, said aligner comprises a body, inscribed by a circle the diameter of which is slightly smaller than the diameter of said accepting bore; and an attachment means for attaching said aligner to said drive bolt, wherein said aligner aligns the central axis of said threaded self tapping insert with the central axis of said accepting bore when inserted therein.

### FIELD OF THE INVENTION

The present invention generally relates to the field of threaded inserts, and more particularly, to a disposable aligner and a method for aligning the central axis of a self-tapping threaded insert with the central axis of its accepting bore, enabling accurate insertion of the self-tapping insert therein.

### BACKGROUND OF THE INVENTION

Modern, well-equipped machine shops today are equipped with the needed technologies for dealing with machining, and restoring of threaded bores with attention to proper alignment of the bore in perpendicular to the work surface. A milling machine or drill press, for example, can be adjusted and used to re-bore a broken, rusted, or worn-out bolt thread by simply drilling an oversized bore perpendicular to the surface and then with the aid of the machine spindle, accurately applying a self-tapping, threaded insert with the correct inner thread to fit the original bolt. The outer self tapping thread of the insert is cutting a new, tight-fitting thread that is mechanically secure for tightening a bolt to the predetermined torque. By using a press drill the alignment is held to high tolerances and the need for a self-aligning tool, such as the aligner of the present invention, is minimal or non-existent.

But there are many situations where service must be provided in the location of the damaged part mostly in agricultural, transportation or industrial equipment. In such cases the use of machine shop equipment is impossible, inconvenient, inaccessible, or too costly and a machinist is called upon to use hand-tools, such as open-ended hexagonal-wrenches, box wrenches, electric-powered or manually driven, heavy-duty screwdrivers, drills, and the like for loosening, removing, reinstalling and tightening loose, broken, or damaged bolts in order to correct a problem. Proper alignment in such cases is of crucial importance in order to preserve the vertical alignment of the bolt with an existing threaded bore. Occasionally the axis of the self cutting insert may be considerably off the mark from the original axis, and the initial insertion may then result in a misaligned self tapping insert mounting as shown in FIG. 1 (Prior Art).

There are, prior art attempts to solve the problem, such as U.S. Pat. No. 4,730,968 to Diperstein et al, which discloses a self-tapping and self-aligning thread repair insert configured with a thread-free portion of a sleeve that is fitted into a smooth bore to align the insert. The length of the thread-free portion seen in U.S. Pat. No. 4,730,968 is at least 1.5 thread pitches from the end of the sleeve. It will be understood to the person skilled in the art, that if this is the actual length, it is clearly insufficient for achieving an initial alignment within the accepting bore and therefore may lead to inaccurate insertion.

If an insert of greater length is employed, insertion of the insert requires extended boring depth to accommodate the added length of the thread-free portion. This may not always be possible since the wall thickness of a work piece may not be sufficient to allow for deeper boring. The thread-free portion itself also requires additional length of the insert.

US Patent Application 2010/0329813 to Strom teaches a self-tapping and self-aligning insert as generally described in the following abstract citation: “The self-tapping insert is aligned within the bore hole by means of a detachable pilot, which is connected to the insert with attachment means. The attachment means include the pilot being attached to the drive bolt. The pilot may be attached to the drive bolt by means of left-handed threads in an axially-centered aperture of the pilot and matching left-handed threads on the end of the drive bolt.”

A major disadvantage of this device is that the pilot needs to be threaded onto a special bolt with a small diameter, partially threaded, extension. Furthermore, using a machined steel pilot adds more labor and manufacturing costs to the finished product. Additionally, there is no solution to the tolerance of the accepting bore when using the pilot, a disadvantage which allows some degree of play in the alignment of the insert assembly and pilot.

The method of the prior art described by Strom requires partial insertion of the self-tapping insert for the first few turns, dismantling the insert itself with the drive bolt then dismantling the pilot and reinstalling the insert back into the few partially threaded pitches and continuing with the insertion of the insert assembly. This method creates the risk of cross-threading in the second step if the initial insertion was insufficient in depth, and the risk that the insert will stick and won't come out in the case of excessive initial insertion depth. Actually, self-tapping inserts should preferably not be slackened once properly inserted, to avoid weakening of the hold. However, Strom is constrained to extract and replace the self tapping insert as well as provide a threaded pilot with left handed threaded extension so as to be strong enough to enable extraction.

Therefore, it would be desirable to provide a method and a device for aligning a threaded self-tapping insert within an accepting bore utilizing standard drive bolt and hexagonal bush or larger nut.

### SUMMARY OF THE INVENTION

Accordingly, it is a principal object of the present invention to overcome the disadvantages and limitations of prior art systems and provide a method and a device for inserting a self-tapping threaded insert into an accepting bore of a work piece so as to coaxially align the central axis of the insert with the central axis of the accepting bore when inserted therein.

According to one embodiment of the present invention, there is provided an aligner for use with threaded self tapping insert, a drive bolt, and a hexagonal bush, the self tapping insert is driven into position in an accepting bore by the drive bolt passed through the hexagonal bush and through the self-tapping insert thread and fitted with the aligner, wherein the aligner comprises:

at least three vertex polygonal body, inscribed by a circle the diameter of which is slightly smaller than that of the accepting bore; and

an attachment means for attaching the aligner to the drive bolt,

According to additional aspect, the above body is made of a semi rigid material and a plurality of wedge-shaped nibs arranged on at least three of said polygonal body vertexes are forming a snug fit when inserted into the accepting bore.

According to another aspect the polygonal body is replaced with a circular body and the wedge-shaped nibs are formed around the circumference of the face portion of said circular body.

According to a different embodiment, the above body is made of a thin resilient material in the shape of a circular shaft-retaining-ring, or of a rigid material in the shape of an internally threaded plain washer, or in the shape of a helical spring washer.

According to another aspect, the drive bolt when fitted with the self tapping insert for insertion into accepting bore is of a given length so as to expose an extended portion of the drive bolt beyond the self-tapping insert, attachable by the attachment means to the aligner.

According to yet another aspect, the attachment means comprises a collar centrally formed on the body of the aligner having an inside diameter suitable for attaching the extended portion of the drive bolt thereto in a temporary snap-fit attachment. Optionally, the collar forms a bore which is open to both directions and the bore end facing the workpiece direction is provided with a circular conical edge serving as a stopper.

According to still another aspect, the aligner further comprises an extension sleeve capable of being mounted over the drive bolt between the hexagonal bush and the self-tapping insert ensuring that the threaded end of the drive bolt is above cutting edges apertures leaving them open for burrs to be removed.

According to a second embodiment, the drive bolt comprises a central bore axially formed therein and an internal extension shaft slid-ably fitted into the central bore which is attachable to said aligner by attachment means to provide longitudinal support along the central axis of said insert at both an upper end of said extension shaft and at a lower end at the body of said aligner within said accepting bore. The attachment means comprises a central aperture formed within the aligner body having an inside diameter configured for temporary snap attachment to the extension shaft.

According to additional aspects, the above aligner body is made of a thin resilient material in the shape of a circular shaft-retaining-ring, or of a rigid material in the shape of an internally threaded plain washer, or in the shape of a helical spring washer.

As indicated above a method is provided for inserting a threaded self-tapping insert into an accepting bore of a work piece with the aid of a drive bolt, a hexagonal bush, an extension sleeve and an aligner as described above,

wherein the method comprises the steps of:

a) providing a drive bolt;

b) sliding the hexagonal bush over the drive bolt;

c) threading the threaded self-tapping insert on the drive bolt to the stop position;

d) attaching the aligner to the drive bolt exposed threaded end using the attachment means;

e) inserting the drive bolt with the hexagonal bush, threaded self-tapping insert and the aligner into the accepting bore;

f) rotating the drive bolt a few turns to insert a few threads of the self-tapping insert into the accepting bore;

g) Slackening the drive bolt with the aid of the hexagonal bush to leave the self tapping insert intact;

h) providing an extension sleeve;

I) repeating steps b to e with the extension sleeve placed between the hexagonal bush and the self tapping insert;

j) further rotating the drive bolt until the self-tapping insert is firmly seated within the accepting bore, flush with the surface of a work piece;

k) Slackening the drive bolt with the aid of the hexagonal bush to leave the self tapping insert intact,

wherein insertion of the drive bolt in step e together with the hexagonal bush, threaded self-tapping insert and aligner into the accepting bore utilizes an upper and lower alignment rest points coaxially aligning the central axes of the insert assembly with that of the accepting bore.

According to another aspect of the described method, in step h a shorter drive bolt is provided instead of an extension sleeve.

According to yet another aspect of the described method, the drive bolt is shorter, further provided with a central bore axially formed therein, fitted with an extension shaft longitudinally movable there-through and attachable to the aligner by the attachment means to provide longitudinal support along the central axis of the insert assembly at both an upper end of the extension shaft and at a lower end at the body of the aligner within the accepting bore and wherein method steps g to i are not needed.

Further features and advantages of the present invention will be apparent from the drawings and description contained herein.

### BRIEF DESCRIPTION OF THE DRAWINGS

Some embodiments of the invention are herein described, by way of example only, with reference to the accompanying drawings. In discussion of the various figures described herein below, like numbers refer to like parts. The drawings are generally not to scale. For clarity, non-essential elements may have been omitted from some of the drawing.

FIG. 1 shows a side view of a self-tapping, insert and drive means of the prior art which failed to align properly when initially threaded into a prepared accepting bore in a work piece;

FIG. 2a shows a top isometric view, of an aligner constructed in accordance with a preferred embodiment of the present invention;

FIG. 2b shows a side, view of an aligner constructed in accordance with a preferred embodiment of the present invention;

FIG. 2c shows a bottom isometric view, of an aligner constructed in accordance with a preferred embodiment of the present invention;

FIG. 2d shows a top isometric view, of an aligner constructed in accordance with a variation of a preferred embodiment of the present invention;

FIG. 2e shows a side, view of an aligner constructed in accordance with the variation of a preferred embodiment of the present invention;

FIG. 2f shows a bottom isometric view, of an aligner constructed in accordance with the variation of a preferred embodiment of the present invention;

FIG. 3a is an exploded view showing the aligner of FIGS. 2a-c in relation to the components comprising a self-aligning, self-tapping insert drive means configured in accordance with a preferred embodiment of the present invention;

FIG. 3b shows a side view of the assembled self-aligning, self-tapping insert and drive means from FIG. 3a ready for initial insertion into a pre-drilled accepting bore in a typical work piece;

FIG. 3c is a cross-section view P-P from FIG. 3b showing details of the insert and drive means;

FIG. 3d is an enlarged, detail view Q from FIG. 3c;

FIG. 4a shows an isometric view of the insert assembly of FIG. 3 showing a first step in the method for self-aligning an insert prior to threading an accepting bore in accordance with principles of the present invention;

FIG. 4b shows side view of the insert assembly of FIG. 3 showing a first step in the method for self-aligning an insert prior to threading an accepting bore in accordance with principles of the present invention;

FIG. 4c shows side cross section view of the insert assembly of FIG. 3 showing a first step in the method for self-aligning an insert prior to threading an accepting bore in accordance with principles of the present invention;

FIG. 5 is an isometric view of another step in the method of the present invention;

FIG. 6a is an exploded view of the insert and drive means of the present invention additionally fitted with an extension sleeve;

FIG. 6b shows a side view of the assembled insert and drive means from FIG. 6a initially being inserted into a typical work piece;

FIG. 6c is a cross-section view S-S from FIG. 6b showing details of the separation and disposition of the aligner at a point inside an accepting bore below a self-tapping insert;

FIG. 7a depicts a stage in the method for utilizing a sleeve for controlled insertion and alignment of a self-tapping insert within an accepting bore;

FIG. 7b shows a view of the final disposition of self-tapping insert shown flush with the surface of a work piece.

FIG. 8a shows a top isometric view of an aligner according to another embodiment of the present invention;

FIG. 8b shows a bottom isometric view of an aligner according to the another embodiment of the present invention;

FIG. 8c shows a side view of an aligner according to the another embodiment of the present invention;

FIG. 9a shows an exploded view of the embodiment of the invention from FIGS. 8a-c in accordance with the principles of the present invention.

FIG. 9b shows a side view of the embodiment of the invention from FIGS. 8a-c in accordance with the principles of the present invention.

FIG. 9c shows a side cross sectional view of the embodiment of the invention from FIGS. 8a-c in accordance with the principles of the present invention.

FIG. 10a depicts an isometric view of an aligner attached to a bolt made in accordance with an additional embodiment of the present invention.

FIG. 10b depicts an isometric view of an aligner seen in FIG. 10a.

FIG. 11a depicts an isometric view of an aligner attached to a bolt made in accordance with another additional embodiment of the present invention.

FIG. 11b depicts an isometric view of an aligner seen in FIG. 11a.

FIG. 12a depicts an isometric view of an aligner attached to a bolt made in accordance with yet another additional embodiment of the present invention.

FIG. 12b depicts an isometric view of an aligner seen in FIG. 12a.

FIG. 13 is an isometric view of the aligner of FIG. 10, fitted to an extension shaft made in accordance to the embodiment of the present invention as shown in FIGS. 8c and 9a.

FIG. 14 is an isometric view of the aligner of FIG. 11, fitted to an extension shaft made in accordance to the embodiment of the present invention as shown in FIGS. 8c and 9a.

FIG. 15 is an isometric view of the aligner of FIG. 12, fitted to an extension shaft made in accordance to the embodiment of the present invention as shown in FIGS. 8c and 9a.

### DETAILED DESCRIPTION OF THE PREFERRED EMBODIMENTS

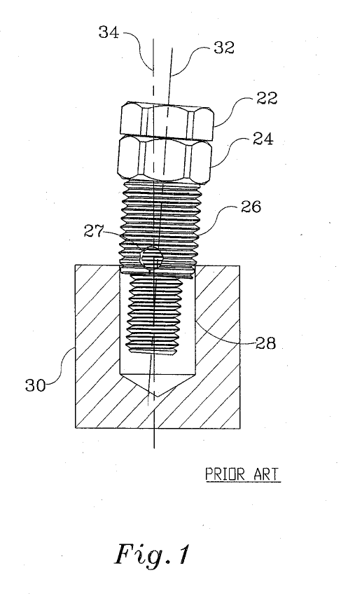

With reference to the drawings, there is shown in FIG. 1, a side view of a self-tapping, insert 26 of the prior art which failed to align properly when initially inserted into a prepared accepting bore 28 in a work piece 30. The self tapping insert 26 is shown with its drive bolt 22 and the bolt release hexagonal bush 24 as will be hereinafter explained.

The prior art self-tapping insert 26 is driven into the accepting bore 28 by a drive bolt 22, and a thru-hole hexagonal bush 24 or hexagonal nut with internal thread bigger than that of the drive bolt 22 such that its thread is not engaged with the thread of the drive bolt 22 and it is free to rotate over the drive bolt 22. The cutting edges of the self-tapping insert 26 are formed by the three apertures 27 (only one seen in this figure). The cutting edges cut a new thread into a smooth accepting bore 28 when properly inserted therein. However, the self-tapping feature shown here and generally used by way of example may be any kind of self-tapping insert as is known by those skilled in the art. For instance, a self-tapping insert may be provided with a number of slots forming the cutting edges.

When initially inserted and threaded into the smooth accepting bore 28 of a typical work piece 30, the drive bolt central axis 32, was incorrectly aligned with the accepting bore central axis 34. When such a thing occurs, one side of the insert tips is less and less engaged with the wall of the accepting bore (as self-tapping insert 26 is inserted deeper) and the other side has to cut deeper into the wall until it sticks. Now it is very difficult to remove the self-tapping insert 26 for reinsertion. Furthermore, even if the self-tapping insert 26 is by chance partly aligned to the extent permitting it to be inserted all the way down, yet it will only aggravate the problem when, at a later stage, during assembly of the reconstructed device, a machine screw is threaded into the inner threads (not shown) of the partly aligned, self-tapping insert 26.

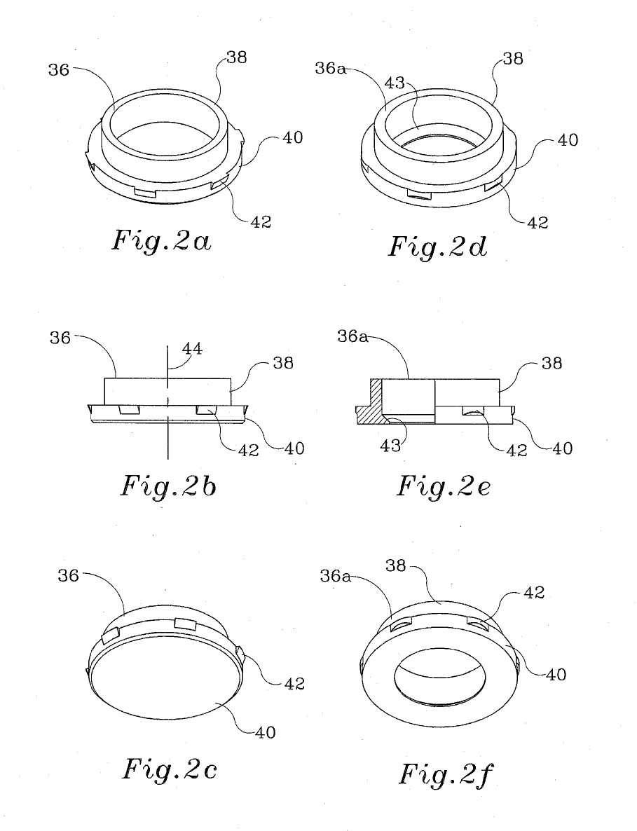

FIGS. 2a-c show various views of a disposable aligner 36 constructed in accordance with one embodiment of the present invention.

FIGS. 2d-f show various views of a disposable aligner 36a constructed in accordance with a variation of embodiment of the present invention.

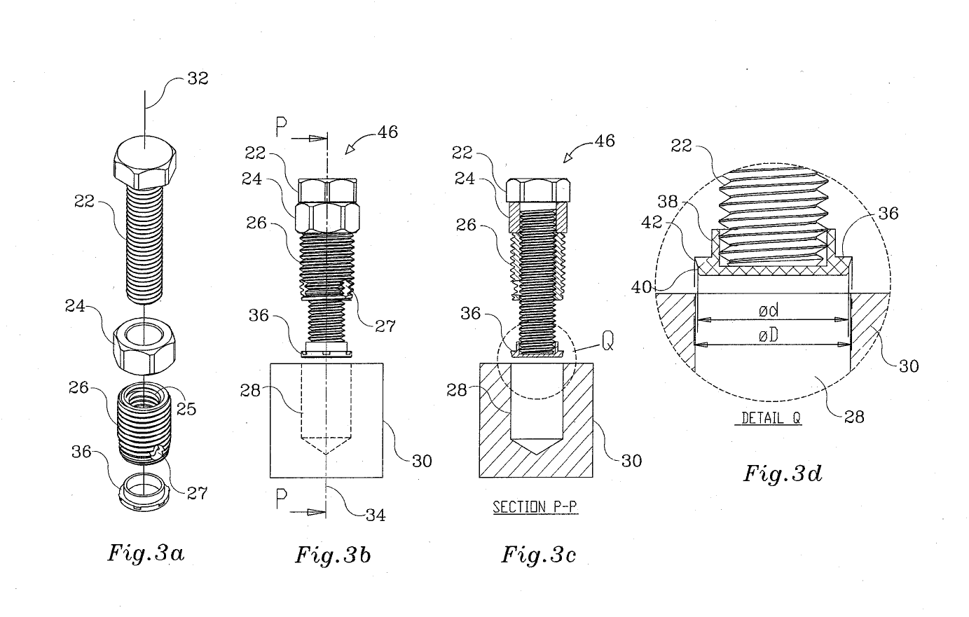

The aligners 36, 36a are constructed as at least three vertex polygonal body 40 inscribed by a circle the diameter of which (marked d in FIG. 3d) is slightly smaller than that of accepting bore 28.

The diameter d of the circle inscribing the body 40 is for example about 0.1 mm. smaller than the lower tolerance of the diameter of an accepting bore 28 (seen in FIG. 3b) into which it is inserted.

Optionally, in order to further improve the alignment accuracy, plurality of wedge-shaped nibs 42 are arranged on at least three of the polygonal body vertexes, forming a snug fit when inserted into the accepting bore 28. The inscribing circle of the plurality of wedge-shaped nibs 42, has a diameter (marked D in FIG. 3d) slightly bigger than that of accepting bore 28 so as to provide a snug fit when pressed into place therein. Optionally, nibs 42 are flexible such that aligners 36 and 36a may be forced into accepting bore 28 by hand force.

In a specific configuration as shown in FIGS. 2a-f the body 40 of aligner 36, 36a accepts a circular shape having a diameter (marked d in FIG. 3d), and the wedge-shaped nibs 42 are formed around the circumference of the face portion 40 of the circular aligner 36 so as to provide a snug fit when aligner 36, 36a is properly inserted into a typical accepting bore 28. The outer diameter (marked D in FIG. 3d) of aligner 36, 36a including the plurality of wedge-shaped nibs 42 is optionally slightly bigger than the maximum acceptable diameter of the accepting bore 28. This ensures perfect alignment in all cases, specifically since most field work is accomplished with manually drilling of bore 28, and such manual drilling cannot be precise. The present invention advantageously allows for this inaccuracy by providing these wedge-shaped nibs 42. It should be noted that the nibs 42 are not essential to the invention, and an aligner as described above without the nibs 42 will perform sufficiently well. Nevertheless, the wedge-shaped nibs 42 makes the aligning more accurate and the alignment process easier to operate on the entire size range of threaded self tapping inserts.

The aligner 36, 36a further comprises a recess for attaching the aligner to bolt 22 (seen in FIG. 3c). The recess or other attachment means, such as collar 38 (FIG. 3d) formed to snap-fit onto the threaded end portion of a drive bolt 22 (FIG. 3a). In FIGS. 2d to 2f, the collar ring bore is shown open to both directions, however, the bore end facing the workpiece 30 direction is optionally provided with a circular conical edge 43 (FIG. 2d) serving as a stopper to prevent further travel of the aligner along drive bolt 22. The conical edge 43 is resting against the chamfered edge normally found on bolts and specifically on drive bolt 22, thus further saving space in the accepting bore 28 as will be hereinafter explained.

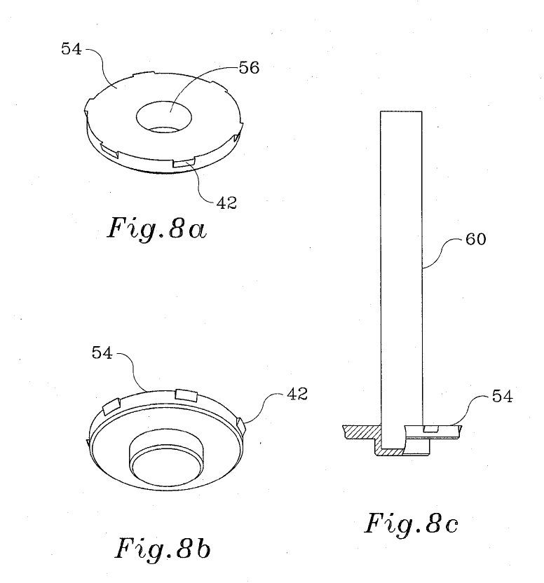

The aligner 36, 36a or 54 (FIGS. 8a-c) is preferably made of plastic, but any suitable rigid or semi rigid materials may also be used.

FIG. 2b shows the central axis 44 of aligner 36 which is automatically centered and self-aligned with its accepting bore central axis 34 (FIG. 3b). When attached to a drive bolt 22 (FIGS. 3a, 3b), and initially inserted into an accepting bore 28 (FIG. 3b), the aligner 36 is constrained to maintain the axial alignment of the drive bolt 22 with the accepting bore central axis 34 to prevent the risk of misalignment, as was shown in FIG. 1 for the prior art.

FIG. 3a is an exploded view of assembly 46 (FIGS. 3b, 3c) showing the aligner 36 of FIGS. 2a-c in relation to the other components needed for a typical self-tapping insert installation configured in accordance with one embodiment of the present invention. A hexagonal-head drive bolt 22 is inserted into a thread-less hexagonal bush 24 and threaded into a self-tapping insert 26, shown by way of example as having three, tapping apertures 27 formed equidistantly around the lower portion thereof. However, any type of self-tapping insert can be used.

An aligner 36 is attached by snap-fitting it to the lower extended portion of the drive bolt 22 prior to insertion of the above units as an assembly 46 (FIGS. 3, 4, 5) into an accepting bore 28 of a work piece 30 (FIG. 3b). This helps to maintain axial alignment between the accepting bore central axis 34 and the drive bolt central axis 32.

Hexagonal bush 24, has no internal threads, but only serves to enable removing of drive bolt 22 from the self-tapping insert 26 without slackening the insert 26 itself when installation is complete.

The first embodiment of the present invention shown in FIGS. 3a-d is intended for use with all kinds of internal threads, with emphasis on those of small-to-medium size. The drive bolt 22 can be provided with any type of head, such as a hexagonal-head, a socket hexagonal head or a Torx head as are known to those skilled in the art.

FIG. 3b shows a side view of the insert 26 and installation components 22, 24, 36 from FIG. 3a ready for initial insertion into a pre-drilled accepting bore 28 of a typical work piece 30. Work piece 30 is shown with an outline view of an accepting bore 28 as indicated by dashed lines, whose central axis 34 is coaxial with that of assembly 46.

The assembly 46 includes drive bolt 22 passed through hexagonal bush 24 and threaded into a self-tapping insert 26 all known from the prior art. The collar 38 of the first embodiment of the present invention is temporarily fitted to the exposed end portion of drive bolt 22 (FIG. 3b). After first step of installation is complete and the drive bolt 22 and hexagonal bush 24 are removed, the collar 38 will loose by itself from its temporary hold on the drive bolt 22, and the disposable aligner 36 will be left in the accepting bore forever.

FIG. 3c is a cross-sectional view along line P-P of FIG. 3b showing details of the assembly 46 and a clearer view of accepting bore 28 in work piece 30.

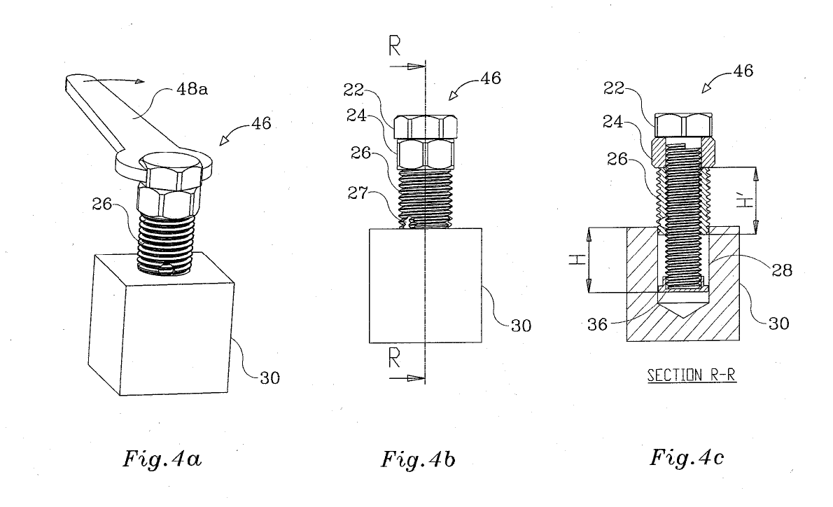

FIG. 3d is an enlarged, cross-sectional, view of the circled area marked Q in FIG. 3c. With attention to the aligner 36 which has been snap-fitted to the exposed portion of drive bolt 22 which extends beyond self-tapping insert 26 for a length marked H (FIG. 4c) which is approximately equal to the height marked H′ (FIG. 4c) of the self-tapping insert 26 in order to assure alignment between the assembly 46 and the central axis 34 of accepting bore 28.

The diameter d (FIG. 3d) of the face portion 40 of aligner 36 is slightly increased by nibs 42 to a diameter D. Because nibs 42 are compressible by nature of the semi rigid material, they are forced inwardly to accept and maintain the exact diameter of the accepting bore which may vary between the diameter d and the diameter D of the inscribing circle of the plurality of wedge-shaped nibs 42 as a result of the non accurate field drilling process described above.

As mentioned above it is one object of the present invention to provide a method of aligning a self tapping threaded insert in its accepting bore.

Accordingly, FIGS. 4a-c are views of the assembly 46 of FIG. 3 showing a first step in the method of aligning a self tapping insert during installation in an accepting bore.

Referring now to FIG. 4a there is shown one embodiment of the method of the present invention for inserting a self tapping insert 26 into an accepting bore 28 which was pre-drilled in a work piece 30. A typical hand tool, such as an open-end wrench 48a is shown by way of example, but other types of suitable tools, optionally including power tool, may be used for this purpose.

The method of the present invention includes a number of steps as will be explained hereinafter with reference to FIGS. 4a to 7c. Once the aligner 36 has been attached to the exposed end of drive bolt 22, using the attachment means, such as collar 38 (FIG. 2), the assembly 46 is constrained to be coaxial with the central axis 34 of accepting bore 28 (see FIG. 3b) and the self-tapping insert 26 is therefore also fully aligned.

An upper alignment rest point is formed when the first threads of self-tapping insert 26 are initially inserted into the opening of accepting bore 28 in work piece 30, and a lower alignment rest point is formed by the aligner 36 which is snugly fitted into accepting bore 28. Since two spaced-apart alignment rest points are established in this way, the entire assembly 46 including the drive bolt 22 act as an axial supporting means to align insert 26 with central axis 34 (see FIG. 3b) of accepting bore 28, accomplishing the purpose of the use of aligner 36 as an aligning tool.

FIG. 4b shows a side view of insert assembly 46 aligned and ready for insertion into work piece 30. It should be noted that during this step the three apertures 27 are substantially above the surface of work piece 30 (only one is visible). This allows burrs created from the initial tapping and threading action of self-tapping insert 26 to be released from accepting bore 28 although their interior side is obstructed by the drive bolt 22. The tapping action is performed by rotating assembly 46 in the direction marked by an arrow by open-end wrench 48a (for the case of right hand tapping).

FIG. 4c is a cross-sectional view along line R-R in FIG. 4b indicating the dimension H of the depth from the surface of work piece 30 to the face of aligner 36 which is approximately equal to the dimension H′ which is the self-tapping insert 26 overall height.

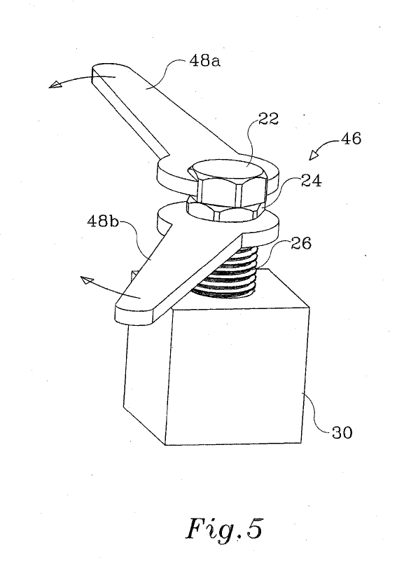

FIG. 5 is an isometric view of following step of the method of the present invention, after a few turns of installation of the insert by drive bolt 22 have been obtained; now all 3 apertures 27 are hidden under the surface of workpiece 30. Insert 26 is now locked into correct position within accepting bore 28. A momentary counter torque (symbolized by curved arrows) applied now to a second wrench 48b while rotating drive bolt 22 with wrench 48a in a counterclockwise loosening movement enables removing drive bolt 22 and hexagonal bush 24 while leaving insert 26 intact. Note that all description herein is for right-hand thread inserts, and reverse directions are used for left-hand inserts.

Aligner 36 is optionally made of inexpensive material such as plastic and intended for one-time use. Aligner 36 is stripped off drive bolt 22 by coming against self-tapping insert 26 when drive bolt 22 is loosened and the hexagonal bush 24 and drive bolt 22 are removed to prepare for the next step in the method of the invention as will be explained hereinafter.

Although aligner 36 has accomplished its purpose, it remains inside accepting bore 28. Depending on the tightness of fit, aligner 36 may remain adjacent to self-tapping insert 26 or may slip further down accepting bore 28. In either case, it does not interfere with the practical aim of threading a new machine screw into the inner threads 25 (FIG. 3a) of self-tapping insert 26 disposed within work piece 30. Aligner 36 is no longer needed for alignment purposes, and it is unimportant and unnecessary to remove it. The effective height of accepting bore 28 consumed by the remaining aligner 36 and specifically the open ended aligner 36a as shown in FIGS. 2d to 2f is minimal and typically the accepting bore should be deeper than the end face of the drive bolt by only 2 mm to 3 mm depending on the size of the threaded self tapping insert.

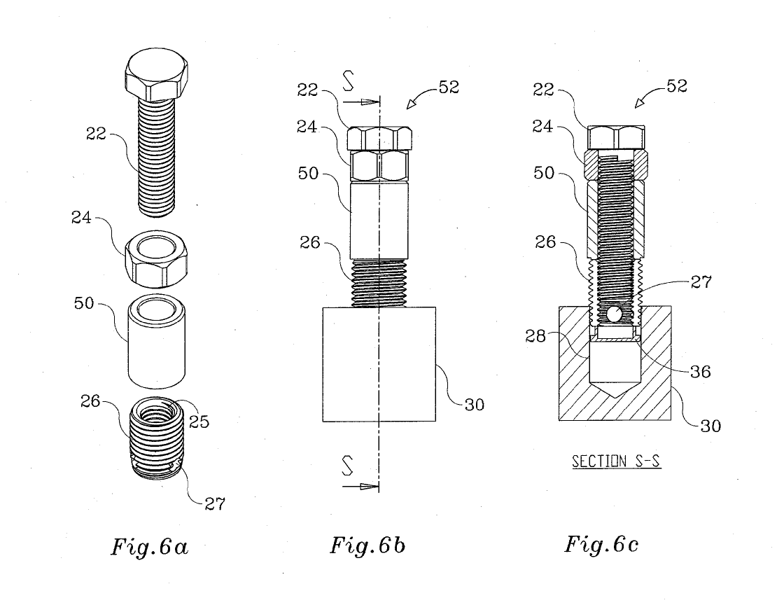

FIGS. 6a-c are various views of continuing steps in the method of the present invention.

FIG. 6a is an exploded view of the insert 26 and installation components for the following method step of the present invention. In addition to the above described components of step 1, the drive bolt 22 is now fitted with an extension sleeve 50. Accordingly, assembly 52 (FIG. 6b) comprises a drive bolt 22 which is inserted through hexagonal bush 24 and thence through an extension sleeve 50 to sit over self-tapping insert 26 provided with three apertures 27 (only one is visible).

FIG. 6b shows a side view of the assembly 52 made of the components from FIG. 6a. The three apertures 27 of the self-tapping insert 26 are already hidden under the surface of workpiece 30 as described above in relation to the previous method step. Adding extension sleeve 50 ensures that the threaded end of drive bolt 22 is above the three cutting edges apertures 27 (FIG. 6c), leaving them open for burrs to be removed. The height of extension sleeve 50 is designed with this in mind, alternately a shorter drive bolt may be used for this method step without extension sleeve 50.

Optionally, extension sleeve 50 may be provided with a circular protrusion on one face (not shown) smaller in diameter than accepting bore 28, intended to locate the upper face of self tapping insert 26 slightly below the surface of workpiece 30.

FIG. 6c is a cross-section view along line S-S in FIG. 6b. Self-tapping insert 26 is shown already set within a first few threads made in accepting bore 28 and the drive bolt 22, hexagonal bush 24, and extension sleeve 50 are assembled and disposed on top of self-tapping insert 26 and tightened against it. By further rotating drive bolt 22, insert 26 is further inserted and set flush with or slightly below (as explained above) the upper surface of work piece 30. Aligner 36 has already been stripped from drive bolt 22 as explained heretofore in relation to FIG. 5 and is depicted here as disposed just below self-tapping insert 26 within accepting bore 28.

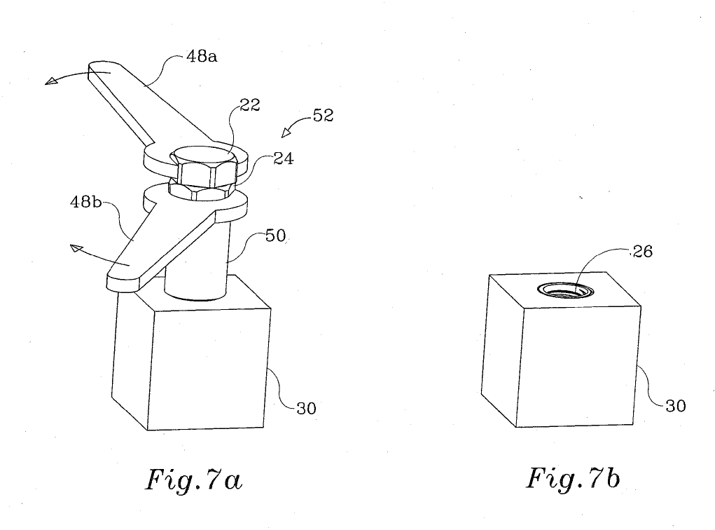

FIGS. 7a-b are various stages in the method for utilizing an extension sleeve for controlled insertion and seating of a self-tapping insert 26 within an accepting bore 28.

FIG. 7a continues the method of the present invention depicting the final step in the method of the present invention, the loosening and removal of drive bolt 22, hexagonal bush 24 and extension sleeve 50. A second wrench 48b applies counter torque to wrench 48a unlocking the components for removal.

FIG. 7b shows a work piece 30 of the final disposition of self-tapping insert 26 shown flush with the surface of work piece 30.

Self-tapping insert 26 is selected for use based on the dimensions of its inner threads 25 (FIG. 3a) which are sized to accommodate a particular size of a machine screw according to the requirements of the fastener needed in a specific application.

FIGS. 8a and 8b show a top isometric and bottom isometric views, respectively of a second embodiment of the present invention for use with sufficiently large self tapping insert thread to allow implementation.

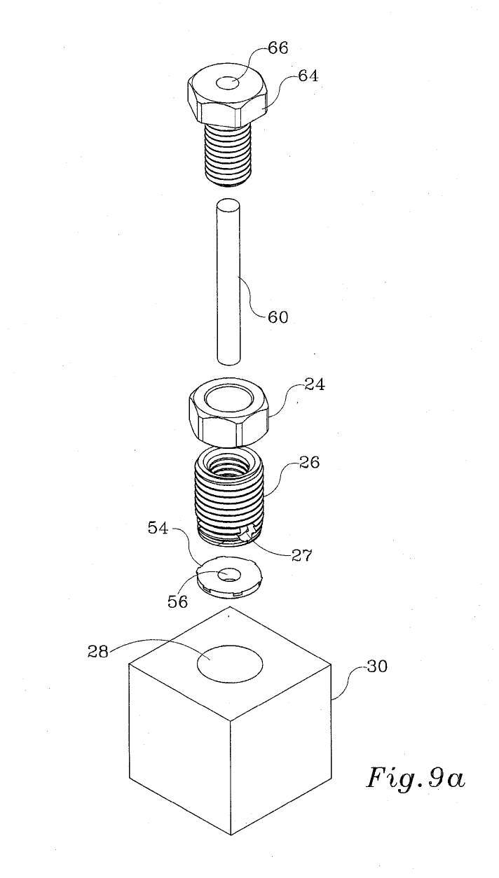

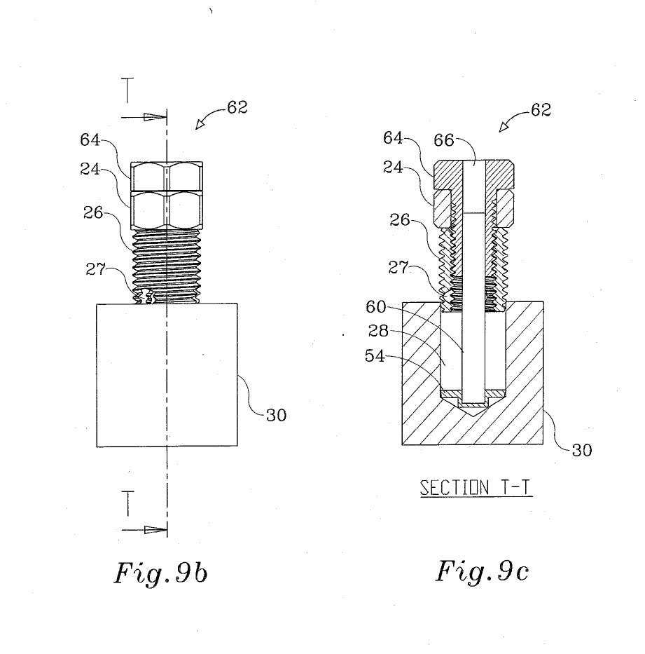

This second embodiment of the present invention provides an aligner 54 for use with a drilled through drive bolt 64 (seen in FIG. 9a) whose diameter is large enough so as to conveniently allow forming a central bore 66 axially therethrough as a practical matter. The large enough diameter of drilled through drive bolt 64 can accommodate the central bore 66 in which an extension shaft 60 can be inserted therethrough and attached to aligner 54 by an attachment means, such as central aperture 56 (see FIG. 8a).

FIG. 8c shows a side view of the aligner 54 from FIGS. 8a, 8b attached to extension shaft 60. aligner 54 is provided with a central bore 56, and optionally a plurality of compressible wedge-shaped nibs 42, and mounted on an extension shaft 60 for insertion into an accepting bore 28 (see FIGS. 9a and 9c).

Aligner 54 is preferably made of plastic, but any suitable semi rigid materials may also be used.

FIGS. 9a-c show various views of the second embodiment of the invention as described in relation to FIGS. 8a-c.

FIG. 9a is an exploded view of the embodiment of the present invention from FIG. 8. Assembly 62 (FIG. 9b) comprises: a hexagonal-head drive bolt 64 provided with a central bore 66, an extension shaft 60, a thru-hole hexagonal bush 24, a self-tapping insert 26 and aligner 54. Note that the hexagonal-head drive bolt 64 is preferably short and when bolted, its threaded end face is above the 3 apertures 27 leaving them open for burrs to pass through. Accordingly there is no need for the extension sleeve 50 while employing this second embodiment of the present invention. The method of applying the invention using this second embodiment will not require the step of removing the drive bolt 64 for placement of the extension sleeve 50. The installation requires only one continuous step of insertion of a self tapping insert 26 until its top face is flat with the workpiece surface level.

FIG. 9b shows a side view of the insert 26 and installation components forming assembly 62 aligned and ready for insertion into an accepting bore 28 (FIG. 9a) of a workpiece 30.

FIG. 9c is a cross-sectional view along line T-T in FIG. 9b. Extension shaft 60 directs aligner 54, to which it is removably attached (see FIG. 8c), to be seated at a low point within accepting bore 28. Alternatively, aligner 54 may be placed there prior to insertion of insert assembly 62. Extension shaft 60 passes through central bore 66 in drive bolt 64 to engage with the attachment means, such as central aperture 56 (see FIG. 8a-b) of aligner 54.

As explained above in relation to FIGS. 4 to 7, an upper alignment rest point is formed when the threads of self-tapping insert 26 are initially inserted into the opening of accepting bore 28 in work piece 30, and a lower alignment rest point is formed by the aligner 54 which is snugly fitted into accepting bore 28, and fitted to the extension shaft 60 which is pushed into the central bore 56 of the aligner 54. Since two spaced-apart alignment rest points are established in this way, the entire assembly 62 including the drive bolt 64 act as an axial supporting means to align insert 26 with central axis of accepting bore 28, accomplishing the purpose of the use of aligner 54 as an aligning tool. Since shaft 60 is free to longitudinally slide in the bore 66 of drive bolt 64 the insertion process may be accomplished in one operation.

FIGS. 10a to 12b shows different aligners made in accordance with additional embodiments of the present invention.

FIG. 10b describes an aligner 70 made of thin resilient material such as carbon steel, stainless steel or phosphor bronze for instance. The aligner is constructed in the shape of a spring type shaft-retaining-ring of the kind used with ungrooved shafts. The springy fingers 72 protruding from the inner circumference of ring 74 towards the center, are configured to match the internal diameter of the drive bolt 22 thread and serve as attachment means instead of the collar ring 38 described herein-above with reference to FIGS. 3c and 3d. The aligner 70 may be provided flat and adopt the thread pitch while fitted to the exposed threaded end of drive bolt 22 (FIG. 10a); or provided with the fingers 72 already bended to match the drive bolt 22 pitch. The aligner 70 may be further provided with external fingers (not shown) protruding on the outer circumference of ring 74, sufficiently upwardly bended, to provide same snug fit functionality as the wedge shaped nibs 42 described herein-above with reference to FIGS. 2a to 2f.

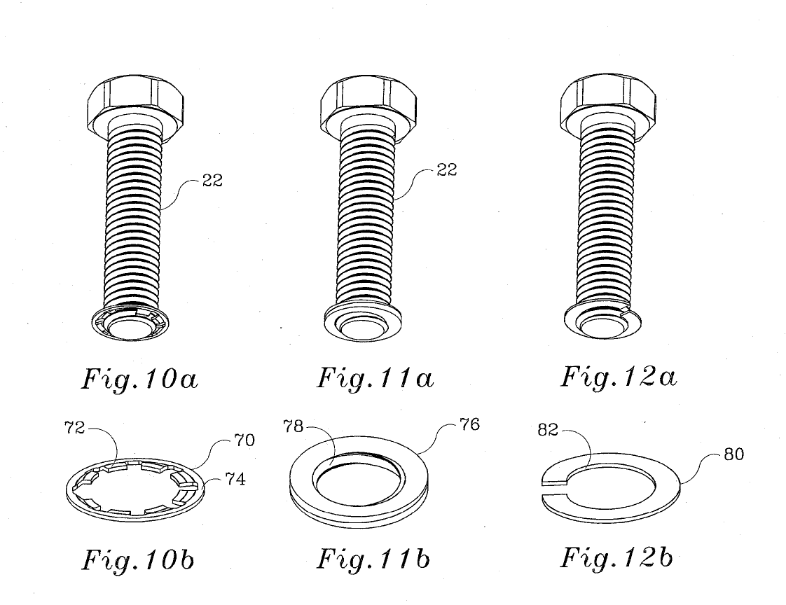

Alternately, in another embodiment as shown in FIG. 11b, the aligner is made as an internally threaded plain washer 76. The short internal thread 78 serves as the attachment means instead of the collar ring 38 described herein-above with reference to FIGS. 3c and 3d. The washer is fitted to the drive bolt 22 as shown in FIG. 11a

In yet another embodiment as shown in FIG. 12b, the aligner is made as a helical spring washer 80 having approximately the same slope as the drive bolt 22 pitch. The spring washer 80 internal circumference 82 serves as attachment means while being engaged with the drive bolt 22 thread as shown in FIG. 12a.

The method of operating aligners 70, 76 and 80 is similar to the method of operating aligner 36, 36a. When removing drive bolt 22 (FIG. 5) the aligner disengages from driving bolt 22 as it rotates counterclockwise. Optionally, aligners 70, 76 and 80 are made of weak materials, and/or with relatively loose engagement with driving bolt 22 such that it would not force self-tapping insert 26 out when bolt 22 is removed.

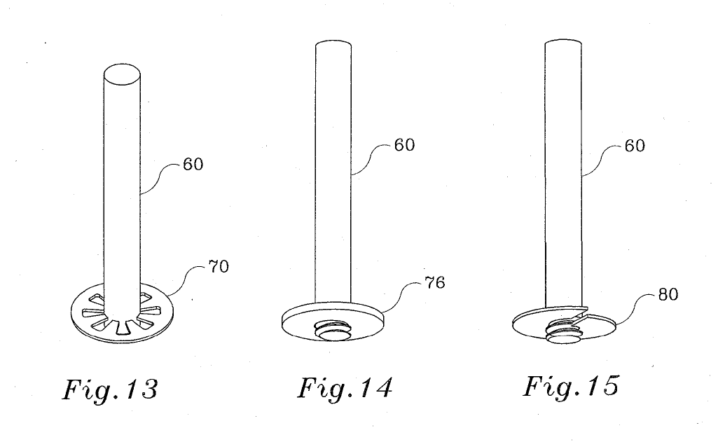

FIGS. 13, 14 and 15 illustrate usage of the aligners as described above with reference to FIGS. 10, 11 and 12 respectively, fitted to an extension shaft 60 as described above with reference to FIGS. 8c and 9a. As shown in FIGS. 14 and 15, the extension shaft 60 may be provided with a short thread at one end thereof. It will be understood that attachment means suitable to attach the aligner 36 to drive bolt 22 as utilized with the first embodiment of the invention may also fit the extension shaft made according to the second embodiment of the present invention.

The method of operating aligners 70, 76 and 80 with shaft 60 is similar to the method of operating aligner 54. When removing shaft 60, the aligner disengages from it by rotating the shaft counterclockwise. Optionally, aligners 70, 76 and 80 are made of weak materials, and/or with relatively loose engagement with shaft 60 such that it would not force self-tapping insert 26 out when the shaft is removed. Optionally, aligners 70, 76 and 80 disengage from shaft 60 simply by pulling hard enough on the shaft.

It will therefore be appreciated that the device described herein and illustrated in the accompanying drawings is set forth merely for purposes of example and that many other variations, modifications, and applications of the present invention may be made.

Having described the present invention with regard to certain specific embodiments thereof, it is to be understood that the description is not meant as a limitation, since further modifications may now become apparent to those skilled in the art, and it is intended to cover such modifications as fall within the scope of the description and appended claims.

What is claimed is:

1. An aligner for use with threaded self tapping insert, a drive bolt, and a hexagonal bush, said self tapping insert is driven into position in an accepting bore by said drive bolt passed through said hexagonal bush and through said self-tapping insert thread and fitted with said aligner, wherein said aligner comprises:
at least three vertex polygonal body, inscribed by a circle the diameter of which is slightly smaller than the diameter of said accepting bore; and
an attachment means for attaching said aligner to said drive bolt,
said aligner aligns the central axis of said threaded self tapping insert with the central axis of said accepting bore when inserted therein.

2. The aligner as claimed in claim 1, wherein said aligner is disposable.

3. The aligner as claimed in claim 1, wherein said body is made of a semi rigid material and a plurality of wedge-shaped nibs arranged on at least three of said polygonal body vertexes are forming a snug fit when inserted into said accepting bore.

4. The aligner as claimed in claim 1, wherein said polygonal body is replaced with a circular body and the wedge-shaped nibs are formed around the circumference of the face portion of said circular body.

5. The aligner as claimed in claim 1, wherein said body is made of a thin resilient material in the shape of a circular shaft-retaining-ring.

6. The aligner as claimed in claim 1, wherein said body has the shape of an internally threaded plain washer.

7. The aligner as claimed in claim 1, wherein said body has the shape of a helical spring washer.

8. The aligner as claimed in claim 1, wherein said inscribing circle has a diameter at least 0.1 mm smaller than the diameter of said accepting bore and the inscribing circle of said plurality of wedge-shaped nibs, has a diameter slightly bigger than said accepting bore.

9. The aligner as claimed in claim 1, wherein said drive bolt, when fitted with said self tapping insert for insertion into said accepting bore is of a sufficient length so as to expose an extended portion of said drive bolt beyond said self-tapping insert.

10. The aligner as claimed in claim 9, wherein said extended portion of said drive bolt is attachable by said attachment means to said aligner.

11. The aligner as claimed in claim 10, wherein said attachment means comprises a collar centrally formed on said body having an inside diameter suitable for attaching said extended portion of said drive bolt thereto in a temporary snap-fit attachment.

12. The aligner as claimed in claim 11, wherein said collar forms a bore which is open to both directions and the bore end facing the workpiece direction is provided with a circular conical edge serving as a stopper.

13. The aligner as claimed in claim 1, further comprising an extension sleeve capable of being mounted over said drive bolt between said hexagonal bush and said self-tapping insert ensuring that the threaded end of said drive bolt is above cutting edges apertures leaving them open for burrs to be removed.

14. The aligner as claimed in claim 13, wherein said extension sleeve is provided with a circular protrusion on one face smaller in diameter than the diameter of said accepting bore, intended to locate the upper face of said self tapping insert slightly below the surface of a workpiece.

15. The aligner as claimed in claim 1, wherein said drive bolt comprises a central bore axially formed therein.

16. The aligner as claimed in claim 15, wherein said drive bolt comprises an internal extension shaft slid-ably fitted into said central bore which is attachable to said aligner by attachment means to provide longitudinal support along the central axis of said insert at both an upper end of said extension shaft and at a lower end at the body of said aligner within said accepting bore.

17. The aligner as claimed in claim 16, wherein said attachment means comprises a central aperture formed within said aligner body having an inside diameter configured for temporary snap attachment to said extension shaft.

18. A method for inserting a threaded self-tapping insert into an accepting bore of a work piece with the aid of a drive bolt, a hexagonal bush, an extension sleeve and an aligner as claimed in claim 1,
wherein said method comprises the steps of:
a) providing a drive bolt;
b) sliding said hexagonal bush over said drive bolt;
c) threading said threaded self-tapping insert on said drive bolt to the stop position;
d) attaching said aligner to said drive bolt exposed threaded end using said attachment means;
e) inserting said drive bolt with said hexagonal bush, threaded self-tapping insert and said aligner into said accepting bore;
f) rotating said drive bolt a few turns to insert a few threads of said self-tapping insert into said accepting bore;
g) Slackening said drive bolt with the aid of said hexagonal bush to leave said self tapping insert intact;
h) providing an extension sleeve;
I) repeating steps b to e with said extension sleeve placed between said hexagonal bush and said self tapping insert;
j) further rotating said drive bolt until said self-tapping insert is firmly seated within said accepting bore, flush with the surface of a work piece;
k) Slackening the drive bolt with the aid of said hexagonal bush to leave the self tapping insert intact,
wherein insertion of said drive bolt in step e together with said hexagonal bush, threaded self-tapping insert and aligner into said accepting bore utilizes an upper and lower alignment rest points coaxially aligning the central axes of the insert assembly with that of said accepting bore.

19. The method as claimed in claim 18, wherein in step h a shorter drive bolt is provided instead of an extension sleeve.

20. The method as claimed in claim 18, wherein said drive bolt is further provided with a central bore axially formed therein, fitted with an extension shaft longitudinally movable there-through and attachable to said aligner by said attachment means to provide longitudinal support along the central axis of said insert assembly at both an upper end of said extension shaft and at a lower end at the body of said aligner within said accepting bore and wherein method steps g to i are not needed.
